(19) United States
(12) Patent Application Publication
(10) Pub. No.: US 2003/0034951 A1
(43) Pub. Date: Feb. 20, 2003

(54) Multi-user, opposable viewing angle display screen

(76) Inventors: Michael A. Fry, Stillwater, MN (US); Robert D.W. Holmen, St. Paul, MN (US)

Correspondence Address: RIDER, BENNETT, EGAN & ARUNDEL, 333 SOUTH SEVENTH STREET, SUITE 2000, MINNEAPOLIS, MN, 55402, US

(21) Appl. No.: 09/930,898

(22) Filed: Aug. 16, 2001

(51) Int. Cl. G09G 5/00

(52) U.S. Cl. 345/156

(57) ABSTRACT

A computer monitor device to allow at least two persons to simutaneously view the same and different information received from a computer. The device has at least two display screens that are mounted as to be independently tiltable to optimal viewing angles. One embodiment has the display screens mounted on a base. In another embodiment, one display screen is mounted on a laptop computer and a second display screen is mounted to the first display screen by a hinge. The two display screens are generally mounted opposite each other. In a third embodiment, two display screens are connected together by swivel linkages that may also carry electrical connectors, allowing the display screens to be daisy-chained together.

### BACKGROUND OF THE INVENTION

The present invention relates to a computer monitor device that allows more than one person to simultaneously view the same or different information from the same source on separate display screens. In particular, the invention allows two or more persons seated opposite each other to view separate display screens that are independently tiltable for optimal viewing angle.

### SUMMARY OF THE INVENTION

A computer monitor device to allow at least two persons to simutaneously view the same information received from a computer. The device has at least two display screens that are mounted as to be independently tiltable to optimal viewing angles. On embodiment has the display screens mounted on a base. In another embodiment, one display screen is mounted on a laptop computer and a second display screen is mounted to the first display screen by a hinge. The two display screens are generally mounted opposite each other.

### BRIEF DESCRIPTION OF THE DRAWINGS

FIG. 1 is a side elevational view of a first embodiment of the present invention.

FIG. 2 is a front elevational view of the embodiment of FIG. 1.

FIG. 3 is a top plan view of the embodiment of FIG. 1.

FIG. 4 is a perspective view of the embodiment of FIG. 1.

FIG. 5 is a perspective view of a second embodiment of the present invention.

FIG. 6 is an alternate perspective view of the embodiment of FIG. 5.

FIG. 7 is a perspective view of a third embodiment of the present invention.

### DETAILED DESCRIPTION OF THE PREFERRED EMBODIMENT

A first embodiment of the computer monitor device of the present invention is generally shown in the Figures as reference numeral 10.

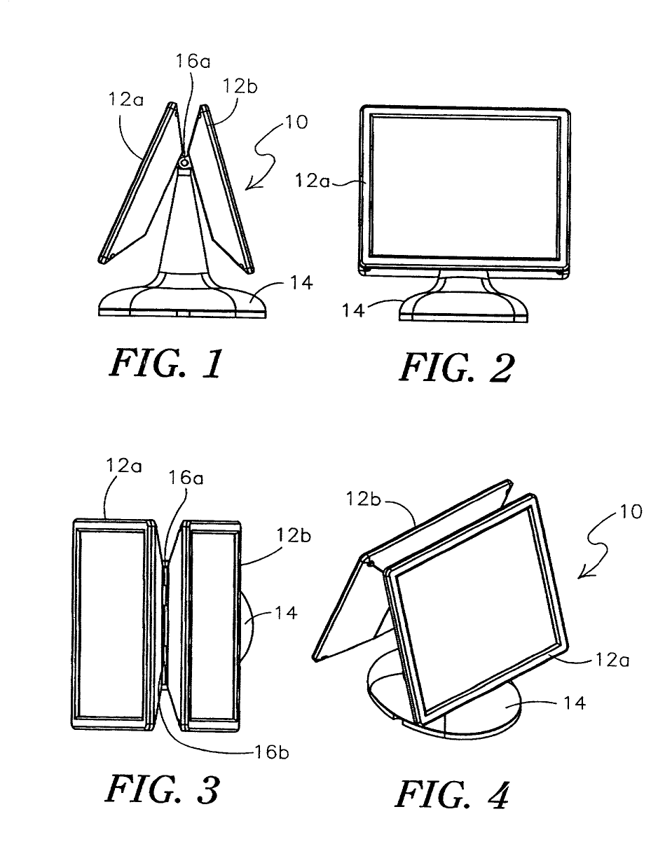

As seen in FIGS. 1-4, the first embodiment 10 comprises at least two display screens 12a, 12b. The screens 12a, 12b simultaneously display the same information from the computer.

The screens 12a, 12b are mounted to a base 14 by means of first 16a and second 16b swivels. The two swivels 16a, 16b allow each of the display screens 12a, 12b to be independently tiltable relative to the base 14 to provide an optimal viewing angle. In the preferred embodiment, the display screens 12a, 12b are mounted on the base 14 one hundred eighty degrees apart from one another, so that two persons sitting opposite one another can simultaneously view the same information.

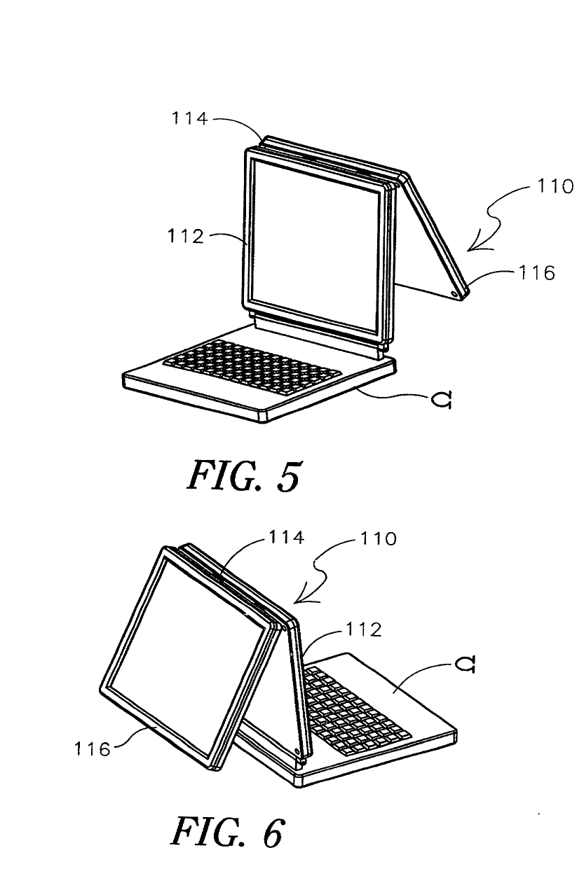

A second embodiment of the present invention, suitable for a laptop computer, is shown in FIGS. 5 and 6.

The second embodiment 110 comprises a first display screen 112 mounted on a computer C. A hinge 114 is mounted to the first display screen 112. A second display screen 116 is mounted on the hinge. The first display screen 112 and second display screen 116 simultaneously display the same information from the computer C. The hinge 114 allows the second display screen 116 to be tilted relative to the first display screen 112 to provide an optimal viewing angle. In the preferred embodiment, the second display screen 116 is mounted one hundred eight degrees from the first display screen 112 on the computer C.

A third embodiment 210 of the present invention allows 3, 4 and more individual display screens 212 to snap fit to support linkages and to daisy chain electrical connectors for viewing around a conference table.

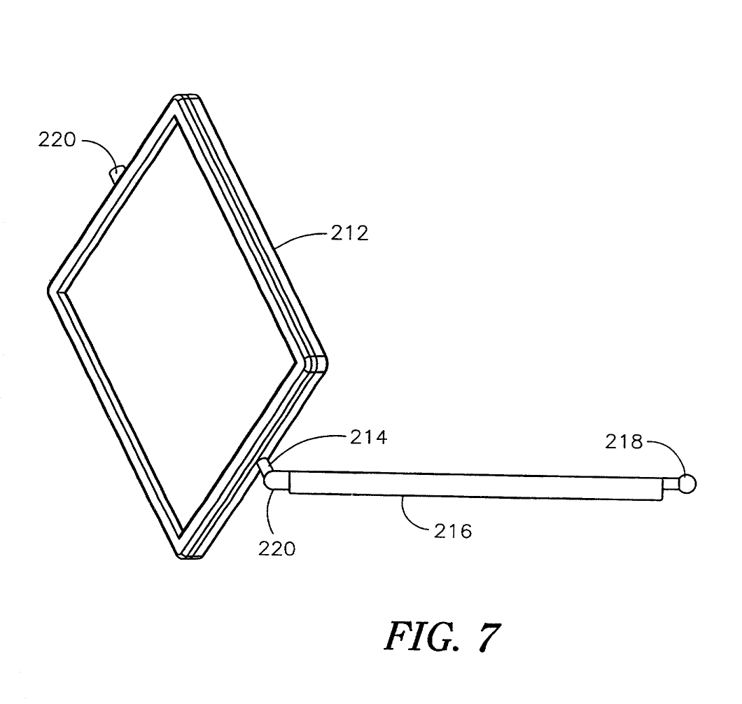

As shown in FIG. 7, the third embodiment 210 comprises a first display screen 212 and a second display screen 216. The first display screen 212 and second display screen 216 are joined together by a linkage 214. The linkage 214 allows the display screens 212, 216 to be swiveled relative to each other about two axes. In the preferred embodiment, the linkage 214 further comprises a ball 218 and socket 220 which snap-fit together. Each of the display screens 212, 216 preferably has a ball 218 at one end of the display screen and a socket 220 at the other end. In this manner, any number of display screens may be joined together around a conference table. The linkages 214 may also carry electrical connectors (not shown) in daisy-chain fashion between adjacent display screens.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A computer monitor device for receiving information from a computer and displaying the received information, comprising:
a) at least two display screens adapted to simultaneously display the same information received from the computer;
b) a base; and
c) a first swivel connecting one of the at least two display screens to the base and a second swivel connecting the other of the at least two display screens to the base
whereby each of the at least two display screens is independently tiltable relative to the base to provide an optimal viewing angle.

2. The computer monitor device of claim 1, wherein the at least two display screens are mounted one hundred eighty degrees apart from each other on the base.

3. A computer monitor device for receiving information from a computer and displaying the received information, comprising:
a) a first display screen mounted to the computer;
b) a hinge mounted on the first display screen; and
c) a second display screen mounted to the hinge
wherein the first display screen and the second display screen simultaneously display the same information received from the computer.

4. The computer monitor device of claim 3, wherein the second display screen is mounted one hundred eighty degrees from the first display screen on the hinge.

5. A computer monitor device for receiving information from a computer and displaying the received information, comprising:
a) a first display screen;
b) a second display screen; and
c) a linkage joining the first display screen to the second display screen
wherein the linkage allows the first display screen and the second display screen to be pivoted relative to each other about two axes.

6. The computer monitor device of claim 5, wherein the linkage further comprises a ball and socket.

7. The computer monitor device of claim 6, wherein the ball and socket snap-fit together.

8. The computer monitor device of claim 5, wherein the linkage is adapted to contain electrical connectors in daisy-chain fashion between adjacent display screens.
